(19) United States
(12) Patent Application Publication
(10) Pub. No.: US 2015/0210554 A1
(43) Pub. Date: Jul. 30, 2015

(54) Carbon-separated Ultrafine Nano Tungsten Carbide Material And Preparation Method And Use Thereof

(71) Applicants: Zhejiang University of Technology, Hangzhou (CN); Hangzhou Sailong Chemical Industry Co., Ltd., Hangzhou (CN)

(72) Inventors: Chun-An Ma, Hangzhou (CN); You-Qun Chu, Hangzhou (CN); Xin-Biao Mao, Hangzhou (CN); Zhao-Yang Chen, Hangzhou (CN); Mei-Qin Shi, Hangzhou (CN)

(21) Appl. No.: 14/495,828

(22) Filed: Sep. 24, 2014

(30) Foreign Application Priority Data
Jan. 29, 2014 (CN) 201410043502.2

(51) Int. Cl. C01B 31/34; B01J 27/22; H01M 4/92

(52) U.S. Cl. CPC C01B 31/34; H01M 4/925; B01J 27/22; C01P 2004/04; C01P 2004/64

(57) ABSTRACT

A carbon-separated ultrafine nano WC material and a method of preparing the same as well as a use thereof, wherein the carbon-separated ultrafine nano WC material is prepared by a method comprising the following steps: (1) a solution of a tungsten source in deionized water is added into a solution prepared from ethanol, concentrated ammonia and a surfactant, wherein the tungsten source is ammonium metatungstate, sodium tungstate or tungsten chloride, and the surfactant is sodium dodecyl benzene sulfonate, ammonium hexadecyl trimethyl bromide or P123; resorcinol is added after intimate agitation; formaldehyde is then added after intimate agitation; and then agitation at room temperature is continued for 8-28 h to produce a mixed solution; (2) the mixed solution is subjected to hydrothermal reaction, and a mixed polymer is obtained after drying; and (3) the mixed polymer is carburized at a high temperature in CO atmosphere to produce the carbon-separated ultrafine nano WC material. The WC material can make the WC particles remain stable in a high-temperature process and avoid secondary agglomeration. It may be used as an electrocatalyst in electrocatalytic reduction of nitro group, and as a support for preparing a supported platinum catalyst. The resultant supported platinum catalyst may be used in anode catalysis in a methanol fuel cell.

### FIELD OF THE INVENTION

The invention relates to an ultrafine nano tungsten carbide material, a method of preparing the same, and a use thereof.

### BACKGROUND

Researchers at home and abroad have conducted a great deal of studies on the development of new catalysts, because catalysts play a very important role in chemical industry. With respect to increase of catalytic activity, current studies are focused predominantly on two directions: increasing the specific surface area of the active components and reducing the particle diameter of the active component particles.

Tungsten carbide (WC) is a non-noble metal material having desirable properties, and exhibits catalytic activity similar to that of platinum. It already shows certain catalytic behavior in the fields of chemocatalysis and electrocatalysis, for example, in fuel cells, catalytic hydrogenation, etc. Noticeably, WC has peculiar characteristics for a good electrocatalyst, such as good acid resistance, electrical conductivity, resistance to CO poisoning, etc. Owing to these unique attributes, WC has a potential of becoming a better catalytic material.

However, a carburization step at high temperature is entailed in the preparation of WC material. In this high-temperature process, crystal grains are inclined to grow easily [Chem. Mater, 2000, 12(12): 3896], and a phenomenon of hard agglomeration of the grains is serious. The agglomeration tends to reduce active sites, and thus the performance of the WC material in such applications as fuel cells and the like is degraded severely. In addition, inordinate agglomeration of the WC nanoparticles inhibits WC from becoming a carrier material having synergistic effect. In order to suppress the agglomeration phenomenon in the high-temperature carburization step, many efforts have been devoted to supporting WC on a carbon material whose high specific surface area is used to disperse tungsten atoms, so that agglomeration of WC particles is prohibited. The research team of the present inventors has done a lot of work in respect of this kind of supporting [Chinese Patent: ZL 201010617226.8; Chinese Patent Application Publication: CN103357408A; etc]. In view of the inventors' long-term work experience, the attributes of ample porosity and high specific surface area of the carbon material fail to have effect on WC dispersion during a supporting step in practical application, because the pores of the carbon material are generally small. Following this concept, development of a new method for preventing agglomeration, especially an in-situ prevention method for use in the course of the formation of a WC material, is expected to be significant for development of the WC material and a method of preparing the same.

Up to now, there have been some reports on WC preparation using prevention methods, for example, Chemistry of Materials, 2010, 22, 966. However, the particles of the resultant WC material are still rather large, and the reason is still the agglomeration of the ultrafine nanoparticles in the high-temperature process. Resorcinol-formaldehyde resin is very common in the market, the reason for which is that the reaction between resorcinol and formaldehyde is easily realizable among polymerization reactions. If this basic polymerization reaction is combined with the development of a preparation method, along with prevention in the polymerization to decrease the particle size of the WC particles after carburization, it is expected to make a breakthrough in the basic research on WC material and its practical application.

### SUMMARY

The first object of the invention is to provide a highly dispersed in-situ carbon-separated ultrafine nano WC material, wherein the ultrafine nano WC particles remain stable in high-temperature process and do not undergo secondary agglomeration.

The second object of the invention is to provide a use of the carbon-separated ultrafine nano WC material as an electrocatalyst in electrocatalytic reduction of nitro group.

The third object of the invention is to provide a supported platinum catalyst prepared by using the carbon-separated ultrafine nano WC material as a support.

The fourth object of the invention is to provide a use of the supported platinum catalyst prepared by using the carbon-separated ultrafine nano WC material as a support in anode catalysis in a methanol fuel cell.

The technical solutions of the invention will be elaborated as follows.

The invention provides a carbon-separated ultrafine nano WC material prepared by a method comprising the following steps:

(1) a solution of a tungsten source in deionized water is added into a solution prepared from ethanol, concentrated ammonia (28 wt %) and a surfactant, wherein the tungsten source is ammonium metatungstate, sodium tungstate or tungsten chloride, and the surfactant is sodium dodecyl benzene sulfonate, ammonium hexadecyl trimethyl bromide or P123; resorcinol is added after intimate agitation; formaldehyde is then added after intimate agitation; and then agitation at room temperature is continued for 8-28 h to produce a mixed solution, wherein the volume ratio of the ethanol, the deionized water, the concentrated ammonia and the formaldehyde is 4-5:10:0.04-0.06:0.1-0.2, the amount by mass of the tungsten source used based on the volume of the deionized water is 0.001-0.004 g/mL, the amount by mass of the surfactant used based on the volume of the deionized water is 0.0004-0.001 g/mL, and the amount by mass of the resorcinol used based on the volume of the deionized water is 0.01-0.015 g/mL;

(2) the mixed solution obtained in step (1) is poured into a hydrothermal reactor to carry out hydrothermal reaction at 80-120° C. for 4-15 h, and a polymer is obtained after drying; and

(3) the polymer obtained in step (2) is carburized at a high temperature of 400-900° C. in CO atmosphere to produce the carbon-separated ultrafine nano WC.

According to the invention, the surfactant has two critical functions: first, the particle diameter of the particles formed from the carbon component is reduced greatly; and second, homogeneous distribution of W atoms is promoted and agglomeration is inhibited. Further, the surfactant is preferably sodium dodecyl benzene sulfonate.

Further, the tungsten source is preferably ammonium metatungstate.

Further, the volume ratio of the ethanol, the deionized water, the concentrated ammonia and the formaldehyde is 4-5:10:0.05:0.1-0.2, the amount by mass of the surfactant used based on the volume of the deionized water is 0.0005 g/mL, the amount by mass of the resorcinol used based on the volume of the deionized water is 0.01-0.0125 g/mL, and the amount by mass of the tungsten source used based on the volume of the deionized water is 0.001-0.004 g/mL. Further, the amount by mass of the tungsten source used based on the volume of the deionized water is 0.001-0.002 g/mL, most preferably 0.001 g/mL.

Still further, the volume ratio of the ethanol, the deionized water, the concentrated ammonia and the formaldehyde is 4:10:0.05:0.175.

Further, the hydrothermal reaction temperature is preferably 80-100° C., and the hydrothermal reaction time is preferably 12-15 hours.

Yet further, the hydrothermal reaction temperature is preferably 100° C., and the hydrothermal reaction time is preferably 12 hours.

Further, the drying temperature in step (2) is preferably 80° C.

Further, a programmed heating-gas/solid reaction process is used for the high-temperature carburization. Specifically, in the course of the programmed heating, the temperature is first raised from room temperature to 400° C. at 1-5° C./min (preferably 1-2.5° C./min, more preferably 2.5° C./min). After held at 400° C. for 1 h, the temperature is raised to 900° C. at the same heating rate to conduct the carburization for 2-6 h (preferably 2-4 h, more preferably 4 h). After the reaction under heating is completed, the carbon-separated ultrafine nano WC material is obtained after cooled to room temperature naturally.

The invention provides a use of the carbon-separated ultrafine nano WC material as an electrocatalyst in electrocatalytic reduction of nitro group. The results show that the ultrafine nano WC material may increase the electrocatalytic conversion efficiency apparently.

The invention also provides a use of the carbon-separated ultrafine nano WC material as a support for a supported platinum catalyst, wherein the supported platinum catalyst is prepared using conventional methods. Furthermore, according to the invention, the supported platinum catalyst comprising the carbon-separated ultrafine nano WC material as a support is used in anode catalysis in a methanol fuel cell, and the results show that the supported platinum catalyst prepared according to the invention exhibits remarkably increased performance in terms of methanol oxidation in the anode reaction in the methanol fuel cell when compared with a catalyst obtained using conventional WC as the support.

In comparison with a prior art WC catalyst or catalyst support, the invention has the following outstanding advantages:

1. Highly homogeneous dispersion of the tungsten component is fulfilled by means of the construction of precursors according to the invention, such that agglomeration of tungsten carbide particles is separated in situ.

2. The formation of carbon is accomplished synchronously during the carburization according to the invention, and thus agglomeration of WC in the high-temperature process is prevented in situ. Hence, the supporting step is dispensed with, and the material loss and energy consumption in the procedure is reduced.

3. The carbon-separated ultrafine nano WC material according to the invention is observed to be in the form of spheres (up to about 200 nm in size) in which the ultrafine WC particles (up to 2-5 nm in particle diameter) are dispersed homogeneously. The particle size distribution of the WC particles is homogeneous. The particles are prevented from contact with each other by carbon, and are present in the form of cores inside the spherical carbon layer. Such a special structure can make the WC particles remain stable in a high-temperature process and avoid secondary agglomeration. In turn, WC that can exist stably and has a small particle diameter will promote the catalytic efficiency and performance of a catalytic material. Hence, the carbon-separated ultrafine nano WC material according to the invention can promote the electrocatalytic conversion efficiency apparently when used as an electrocatalyst in electrocatalytic reduction of nitro group, and a supported platinum catalyst using it as a support exhibits remarkably increased performance in terms of methanol oxidation in anode reaction in a methanol fuel cell when compared with a catalyst obtained using conventional WC as the support

### BRIEF DESCRIPTION OF THE DRAWINGS

FIG. 1 shows a TEM image of the sample according to Example 1.

FIG. 2 shows a TEM image of the sample according to Example 3.

FIG. 3 shows an SEM image of the sample obtained according to Example 8 (Comparative Example 2).

FIG. 4 shows linear scanning curves obtained in electrocatalytic reduction of nitro group using the samples according to Examples 4 and 8, wherein (a) represents the sample according to Example 4, and (b) represents the sample according to Example 8.

FIG. 5 shows linear scanning curves obtained in electrocatalytic oxidation of methanol using the Example 3 sample and the Example 8 sample which support platinum by the same method, wherein (a) represents the sample according to Example 3, and (b) represents the sample according to Example 8.

### DETAILED DESCRIPTION

The technical solutions of the invention will be illustrated with reference to the following specific examples, but the protection scope of the invention is not limited thereto.

### Example 1

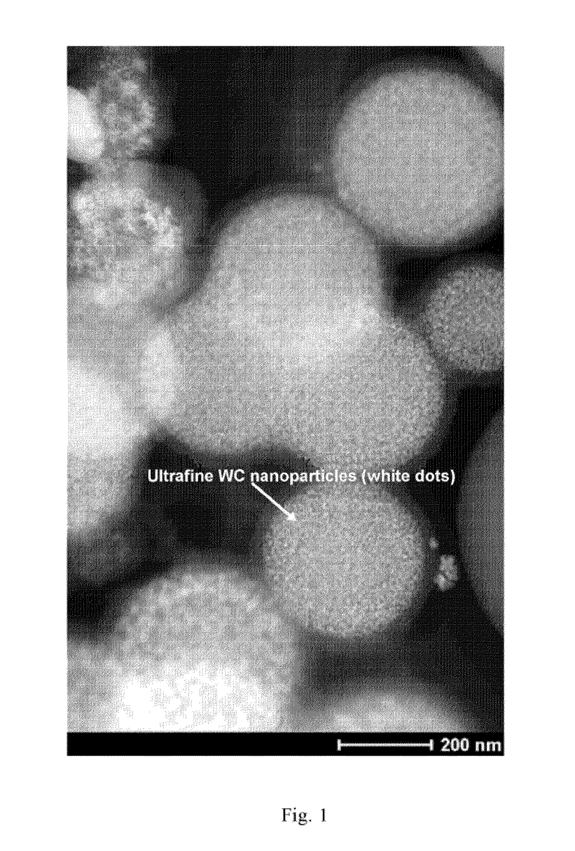

0.08 g ammonium metatungstate was added to 50 ml deionized water, and after agitation, mixed with a solution prepared from 25 ml ethanol, 0.2 ml concentrated ammonia solution and 0.05 g sodium dodecyl benzene sulfonate. After agitation, 0.5 g resorcinol was added, and agitated for 30 min. Then, 0.5 ml formaldehyde was added, and agitated at room temperature for 24 h. Subsequently, the resultant was transferred into a hydrothermal reactor, and held in a forced air drying oven at 120° C. for 15 h. The compound obtained was dried in a forced air drying oven at 80° C. In a high-temperature tubular furnace, CO gas at 200ml/min was chosen as the carburization gas. The temperature was raised from room temperature to 400° C. at 5° C./min. After held at 400° C. for 1 h, the temperature was raised to 900° C. at the same heating rate and held for 6 h. After cooled to room temperature naturally, the powder obtained was the carbon-separated ultrafine nano WC material whose morphology was shown in FIG. 1. The WC component was well dispersed. However, local agglomeration was observed. The particle diameter of the highly dispersed ultrafine nano WC particles was about 10 nm.

### Example 2

0.02 g ammonium metatungstate was added to 10 ml deionized water, and after agitation, mixed with a solution prepared from 5 ml ethanol, 0.05 ml concentrated ammonia solution and 0.005 g sodium dodecyl benzene sulfonate. After agitation, 0.1 g resorcinol was added, and agitated for 30 min. Then, 0.1 ml formaldehyde was added, and agitated at room temperature for 8 h. Subsequently, the resultant was transferred into a hydrothermal reactor, and held in a forced air drying oven at 80° C. for 12 h. The polymer obtained was dried in a forced air drying oven at 80° C. In a high-temperature tubular furnace, CO gas at 50 ml/min was chosen as the carburization gas. The temperature was raised from room temperature to 400° C. at 1° C./min. After held at 400° C. for 1 h, the temperature was raised to 900° C. at the same heating rate and held for 2 h. After cooled to room temperature naturally, the powder obtained was the carbon-separated ultrafine nano WC material but at a smaller yield. The WC particle diameter was about 2 nm.

### Example 3

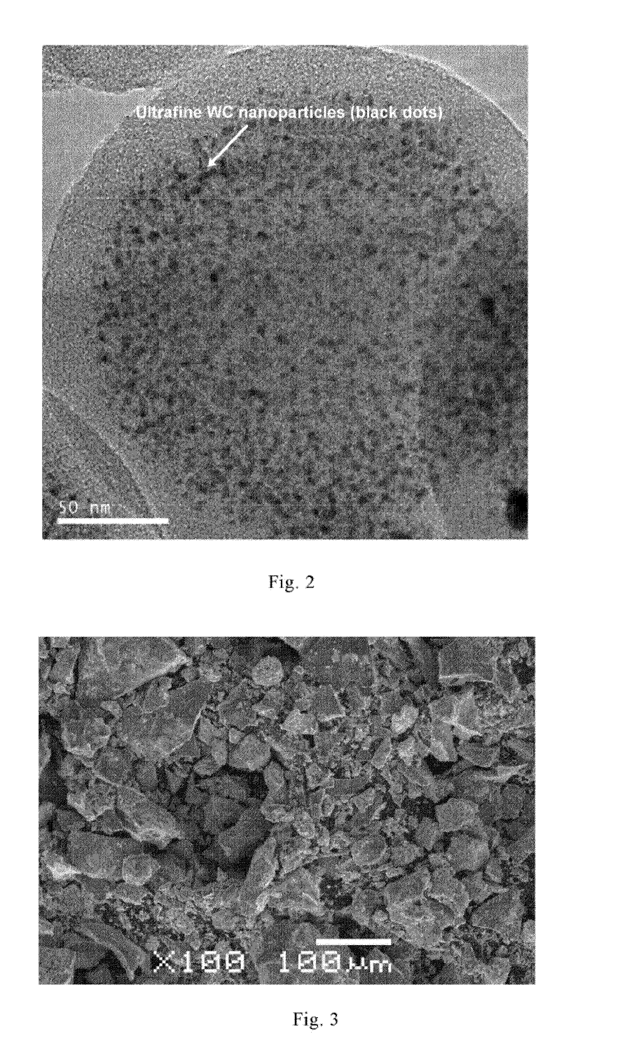

0.02 g ammonium metatungstate was added to 20 ml deionized water, and after agitation, added to a solution prepared from 8 ml ethanol, 0.1 ml concentrated ammonia solution and 0.01 g sodium dodecyl benzene sulfonate. After agitation, 0.25 g resorcinol was added, and agitated for 30 min. Then, 0.35 ml formaldehyde was added, and agitated at room temperature for 24 h. Subsequently, the resultant was transferred into a hydrothermal reactor, and held in a forced air drying oven at 100° C. for 12 h. The polymer obtained was dried in a forced air drying oven at 80° C. In a high-temperature tubular furnace, the temperature was raised from room temperature to 400° C. at 2.5° C./min. CO gas at 150 ml/min was chosen as the carburization gas. After held at 400° C. for 1 h, the temperature was raised to 900° C. at the same heating rate and held for 4 h. After cooled to room temperature naturally, the powder obtained was the carbon-separated ultrafine nano WC material whose morphology was shown in FIG. 2. The particle diameter of the carbon component particles was up to 250 nm. The WC particle diameter was about 2 nm.

### Example 4

0.08 g ammonium metatungstate was added to 20 ml deionized water, and after agitation, added to a solution prepared from 8 ml ethanol, 0.1 ml concentrated ammonia solution and 0.01 g sodium dodecyl benzene sulfonate. After agitation, 0.25 g resorcinol was added, and agitated for 0.5 h. Then, 0.35 ml formaldehyde was added, and agitated at room temperature for 24 h. Subsequently, the resultant was transferred into a hydrothermal reactor, and held in a forced air drying oven at 100° C. for 12 h. The polymer obtained was dried in a forced air drying oven at 80° C. In a high-temperature tubular furnace, CO gas at 150 ml/min was chosen as the carburization gas. The temperature was raised from room temperature to 400° C. at 2.5° C./min. After held at 400° C. for 1 h, the temperature was raised to 900° C. at the same heating rate and held for 4 h. After cooled to room temperature naturally, the powder obtained was the carbon-separated ultrafine nano WC material. The WC particle diameter was about 5 nm.

### Example 5

0.05 g sodium tungstate was added to 25 ml deionized water, and after agitation, added to a solution prepared from 12 ml ethanol, 0.15 ml concentrated ammonia solution and 0.01 g ammonium hexadecyl trimethyl bromide. After agitation, 0.3 g resorcinol was added, and agitated for 0.5 h. Then, 0.3 ml formaldehyde was added, and agitated at room temperature for 20 h. Subsequently, the resultant was transferred into a hydrothermal reactor, and held in a forced air drying oven at 110° C. for 12 h. The polymer obtained was dried in a forced air drying oven at 80° C. In a high-temperature tubular furnace, CO gas at 150 ml/min was chosen as the carburization gas. The temperature was raised from room temperature to 400° C. at 3° C./min. After held at 400° C. for 1 h, the temperature was raised to 900° C. at the same heating rate and held for 4 h. After cooled to room temperature naturally, the powder obtained was the carbon-separated ultrafine nano WC material. The WC particle diameter was about 15 nm.

### Example 6

25 ml deionized water and 0.05 g tungsten chloride were mixed by agitation and then added to a solution prepared from 12 ml ethanol, 0.15 ml concentrated ammonia solution and 0.01 g P123. After agitation, 0.3 g resorcinol was added, and agitated for 0.5 h. Then, 0.3 ml formaldehyde was added, and agitated at room temperature for 20 h. Subsequently, the resultant was transferred into a hydrothermal reactor, and held in a forced air drying oven at 110° C. for 12 h. The polymer obtained was dried in a forced air drying oven at 80° C. In a high-temperature tubular furnace, CO gas at 150 ml/min was chosen as the carburization gas. The temperature was raised from room temperature to 400° C. at 3° C./min. After held at 400° C. for 1 h, the temperature was raised to 900° C. at the same heating rate to conduct carburization for 4 h. After cooled to room temperature naturally, the powder obtained was the carbon-separated ultrafine nano WC material. The WC particle diameter was about 30 nm.

### Example 7

### Comparative Example 1 (Without Addition of Surfactant)

20 ml deionized water and 0.02 g ammonium metatungstate were mixed by agitation and then added to a solution prepared from 8 ml ethanol and 0.1 ml concentrated ammonia. After agitation, 0.25 g resorcinol was added, and agitated for 0.5 h. Then, 0.35 ml formaldehyde was added under agitation, and agitated at room temperature for 24 h. Subsequently, the resultant was transferred into a hydrothermal reactor, and held in a forced air drying oven at 100° C. for 12 h. The polymer obtained was dried in a forced air drying oven at 80° C. In a high-temperature tubular furnace, the temperature was raised from room temperature to 400° C. at 2.5° C./min. CO gas at 150 ml/min was chosen as the carburization gas. After held at 400° C. for 1 h, the temperature was raised to 900° C. at the same heating rate and held for 4 h. After cooled to room temperature naturally, the particle size of the powder carbon component particles obtained was up to 700 nm. However, agglomeration of the WC particles was serious, and a relatively large amount of needlelike particles were formed.

### Example 8

### Comparative Example 2

Particles of ammonium metatungstate precursor were placed in a quartz boat and then transferred into a tubular furnace. Similarly, the flow of the carburization gas CO was 150 ml/min, the programmed heating rate was 2.5° C./min, and after held at 400° C. for 1 h, the temperature was raised to 900° C. at the same heating rate to conduct carburization for 4 h. The SEM morphology of the product was shown in FIG. 3. It can be seen that the particles are very large, and the size of some particles is up to hundred micrometers. As indicated by the comparative example, the WC particles treated by the method of the invention is reduced by orders of magnitude as compared with the WC particles of the comparative example.

### Example 9

### Use Example 1

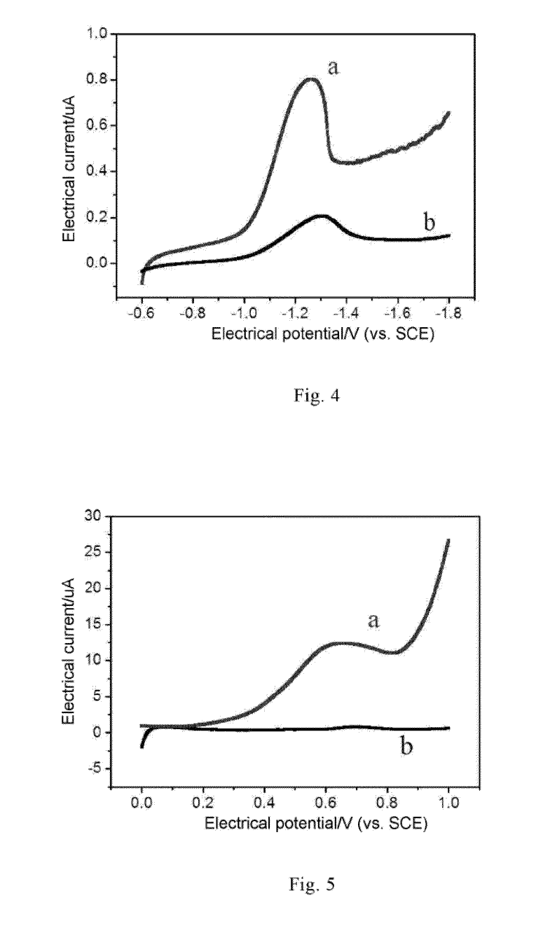

The samples obtained in Examples 4 and 8 were subjected to performance test in electrocatalytic reduction of nitro group. The linear scanning curves in FIG. 4, which are main means for characterizing electrocatalytic reactions, show the test results which are data obtained from the two samples under the same test conditions (scanning speed: 50 mV/s; the behavior of a 0.03 mol/L nitrobenzene solution in the reduction of nitro group on a powder microelectrode filled with the test sample was measured). As indicated by the curves in the figure, the catalytic performance of the ultrafine nano WC obtained in Example 4 is obviously better than that of the sample obtained in Example 8. This may be attributed mainly to (1) the increased active area for the reaction resulted from the high dispersion of the WC component and the greatly reduced particle diameter; and (2) the improved unit catalytic effect resulted from the nanosize effect generated thereby.

### Example 10

### Use Example 2

The ultrafine nano WC obtained in Example 3 and the comparative sample obtained in Example 8 were used as supports to prepare supported platinum catalysts by the same method (microwave heating—ethylene glycol reduction process). The supported platinum catalysts were prepared according to the method disclosed by ACTA CHIMICA SINICA, 2011, 69, 1029. Electrocatalytic oxidation of methanol is anode reaction of a methanol direct fuel cell. The test method for electrocatalytic oxidation of methanol was conducted under the following conditions: scanning speed: 50 mV/s; solution: 1M sulfuric acid+2M methanol.

The data results are shown in FIG. 5. As indicated by this figure, when the WC material obtained according to the invention was used as the support, the performance was promoted by orders of magnitude at the same load of Pt, and the catalytic activity for the methanol oxidation in the anode reaction in the methanol fuel cell was increased greatly as compared with the catalyst obtained by using conventional WC as the support.

1. A carbon-separated ultrafine nano WC material prepared by a method comprising the following steps:
(1) a solution of a tungsten source in deionized water is added into a solution prepared from ethanol, concentrated ammonia and a surfactant, wherein the tungsten source is ammonium metatungstate, sodium tungstate or tungsten chloride, and the surfactant is sodium dodecyl benzene sulfonate, ammonium hexadecyl trimethyl bromide or P123; resorcinol is added after intimate agitation; formaldehyde is then added after intimate agitation; and then agitation at room temperature is continued for 8-28 h to produce a mixed solution, wherein the volume ratio of the ethanol, the deionized water, the concentrated ammonia and the formaldehyde is 4-5:10:0.04-0.06:0.1-0.2, the amount by mass of the tungsten source used based on the volume of the deionized water is 0.001-0.004 g/mL, the amount by mass of the surfactant used based on the volume of the deionized water is 0.0004-0.001 g/mL, and the amount by mass of the resorcinol used based on the volume of the deionized water is 0.01-0.015 g/mL;
(2) the mixed solution obtained in step (1) is poured into a hydrothermal reactor to carry out hydrothermal reaction at 80-120° C. for 4-15 h, and a polymer is obtained after drying; and
(3) the polymer obtained in step (2) is carburized at a high temperature of 400-900° C. in CO atmosphere to produce the carbon-separated ultrafine nano WC material.

2. The carbon-separated ultrafine nano WC material of claim 1, wherein the surfactant is sodium dodecyl benzene sulfonate and the tungsten source is ammonium metatungstate.

3. The carbon-separated ultrafine nano WC material of claim 1, wherein the volume ratio of the ethanol, the deionized water, the concentrated ammonia and the formaldehyde is 4-5:10:0.05:0.1-0.2, the amount by mass of the surfactant used based on the volume of the deionized water is 0.0005 g/mL, the amount by mass of the resorcinol used based on the volume of the deionized water is 0.01-0.0125 g/mL, and the amount by mass of the tungsten source used based on the volume of the deionized water is 0.001-0.004 g/mL.

4. The carbon-separated ultrafine nano WC material of claim 3, wherein the amount by mass of the tungsten source used based on the volume of the deionized water is 0.001-0.002 g/mL.

5. The carbon-separated ultrafine nano WC material of claim 4, wherein the volume ratio of the ethanol, the deionized water, the concentrated ammonia and the formaldehyde is 4:10:0.05:0.175, and the amount by mass of the tungsten source used based on the volume of the deionized water is 0.001 g/mL.

6. The carbon-separated ultrafine nano WC material of claim 1, wherein the hydrothermal reaction temperature is 80-100° C., and the hydrothermal reaction time is 12-15 hours.

7. The carbon-separated ultrafine nano WC material of claim 6, wherein the hydrothermal reaction temperature is 100° C., and the hydrothermal reaction time is 12 hours.

8. The carbon-separated ultrafine nano WC material of claim 1, wherein step (3) is carried out specifically as follows: the polymer is placed in a tubular furnace, heated from room temperature to 400° C. at 1-5° C./min, held at 400° C. for 1 h, heated to 900° C. at the same heating rate to conduct the carburization for 2-6 h, and cooled to room temperature naturally once the reaction under heating is completed, so as to obtain the carbon-separated ultrafine nano WC material.

9. The carbon-separated ultrafine nano WC material of claim 8, wherein step (3) is carried out specifically as follows: the polymer is placed in the tubular furnace, heated from room temperature to 400° C. at 2.5° C./min, held at 400° C. for 1 h, heated to 900° C. at the same heating rate to conduct the carburization for 4 h, and cooled to room temperature naturally once the reaction under heating is completed, so as to obtain the carbon-separated ultrafine nano WC material.

10. Use of the carbon-separated ultrafine nano WC material of claim 1 as an electrocatalyst in electrocatalytic reduction of nitro group.

11. A supported platinum catalyst prepared by using the carbon-separated ultrafine nano WC material of claim 1 as a support.

12. Use of the supported platinum catalyst of claim 11 in anode catalysis in a methanol fuel cell.
